(19) United States
(12) Patent Application Publication
(10) Pub. No.: US 2019/0099849 A1
(43) Pub. Date: Apr. 4, 2019

(54) THERMAL DISPLACEMENT COMPENSATION SYSTEM

(71) Applicant: FANUC CORPORATION, Yamanashi (JP)

(72) Inventors: Keita HADA, Yamanashi (JP); Kazunori IIJIMA, Yamanashi (JP)

(21) Appl. No.: 16/143,463

(22) Filed: Sep. 27, 2018

(30) Foreign Application Priority Data
Oct. 4, 2017 (JP) 2017-194039

(51) Int. Cl. B23Q 15/18; B23Q 11/00; G05B 19/404

(52) U.S. Cl. CPC B23Q 15/18; B23Q 11/0007; G05B 2219/49219; B23Q 2220/006; G05B 2219/49206; G05B 19/404

(57) ABSTRACT

A thermal displacement compensation system detects a state quantity indicating a state of an operation of a machine, infers a thermal displacement compensation amount of the machine from the detected state quantity, and performs a thermal displacement compensation of the machine based on the inferred thermal displacement compensation amount, of the machine. The thermal displacement compensation system generates a learning model by machine learning that uses a feature quantity and stores the generated learning model in association with a combination of specified conditions of the operation of the machine.

### BACKGROUND OF THE INVENTION

### 1. Field of the Invention

The present invention relates to a thermal displacement compensation system and, particularly, to a thermal displacement compensation system which performs a compensation while switching learning models in accordance with an installation environment of a machine in a factory.

### 2. Description of the Related Art

In a machine, since a feed screw and a spindle are driven by a motor, the feed screw and the spindle expand and a machine position changes due to heat generated by the motor, frictional heat created by a rotation of a bearing, and frictional heat in a contact portion between a ball screw and a ball nut of the feed screw. In addition, since a change in ambient temperature of the machine and the use of a coolant also cause a change in column and bed temperatures, the machine position changes due to elongation or inclination induced by such a temperature change. In other words, a deviation occurs in a relative positional relationship between a workpiece to be positioned and a tool. Such a change in the machine position due to heat becomes an issue when performing machining with high accuracy.

In order to eliminate such a displacement in a machine position due to heat, a technique for compensating a command position using a displacement sensor, a technique for compensating a command position by predicting a thermal displacement from operating conditions such as the number of rotations of a spindle, and a structure which circumvents the effect of thermal expansion by imparting an initial tension to a feed screw have been used (refer to Japanese Patent Application Laid-open No. 2002-086329, Japanese Patent Application Laid-open. No. 2006-055919, and Japanese Patent Application Laid-open No. 2008-183653).

However, a state of a thermal displacement of a machine is greatly affected not only by an operating state of the machine itself but also by an environment in which the machine is installed. For example, a state of a thermal displacement of a machine may differ depending on whether or not the machine is installed in a temperature-controlled room, whether or not a door of the room in which the machine is installed is open, whether or not an air conditioner or a heater is installed in the room in which the machine is installed, what kind of operating state other machines in the room in which the machine is installed are in, and the like even if the operating state is the same. Therefore, it is essential to take an installation environment of a machine into consideration in order to perform a thermal displacement compensation of the machine in an appropriate manner.

While a machine learning device which takes an operating state and an installation environment of a machine into consideration may conceivably be introduced in order to perform a thermal displacement compensation of the machine, creating a general-purpose machine learning device (a general-purpose learning model) capable of accommodating a wide variety of situations as described above requires a large volume of state information detected in various situations and, in addition, known problems such as over-learning may occur due to the necessity of many parameters including data related to such various situations.

### SUMMARY OF THE INVENTION

In consideration thereof, an object of the present invention is to provide a thermal displacement compensation system that enables appropriate thermal displacement compensation which takes an installation environment of a machine into consideration to be more widely performed.

The thermal displacement compensation system according to the present invention solves the problem described above by providing a mechanism for switching learning models used to determine thermal displacement, compensation of a machine in a factory in accordance with an installation environment of the machine. The thermal displacement compensation system according to the present invention has a plurality of learning models, selects a learning model in accordance with an installation environment or the like of a machine in a factory, performs machine learning based on a state quantity detected from the machine with respect to the selected learning model, and performs a thermal displacement compensation of the machine in a factory by selectively using learning models created in this manner in accordance with an installation environment or the like of the machine.

A thermal displacement compensation system according to an aspect of the present invention performs a thermal displacement compensation of a machine, the thermal displacement compensation system including: a condition specifying section which specifies a condition of an operation of the machine; a state quantity detecting section which detects a state quantity indicating a state of the operation of the machine; an inferential calculation section which infers a thermal displacement compensation amount of the machine from the state quantity; a compensation executing section which performs a thermal displacement compensation of the machine based on the thermal displacement compensation amount of the machine inferred by the inferential calculation section; a learning model generating section which generates or updates a learning model by machine learning that uses the state quantity; and a learning model storage section which stores at least one leasing model generated by the learning model generating section in association with a combination of conditions specified by the condition specifying section. In addition, the inferential calculation section is configured to infer the thermal displacement compensation amount of the machine by selectively using, based on the condition of the operation of the machine specified by the condition specifying section, at least one learning model from the learning models stored in the learning model storage section.

The thermal displacement compensation system may further include a feature quantity creating section which creates a feature quantity characterizing a thermal state due to the operation of the machine, from the state quantity detected by the state quantity detecting section, wherein the inferential calculation section may infer the thermal displacement compensation amount of the machine from the feature quantity, and the learning model generating section may generate or update the learning model by machine learning that uses the feature quantity.

The learning model generating section may generate a new learning model by performing a modification of an existing learning model stored by the learning model storage section.

The learning model storage section may encrypt and store the learning model generated by the learning model generating section and decrypt the encrypted learning model when the learning model is read by the inferential calculation section.

A thermal displacement compensation system according to another aspect of the present invention performs a thermal displacement compensation of a machine, the thermal displacement compensation system including: a condition specifying section which specifies a condition of an operation of the machine; a state quantity detecting section which detects a state quantity indicating a state of the operation of the machine; an inferential calculation section which infers a thermal displacement compensation amount of the machine from the state quantity; a compensation executing section which performs a thermal displacement compensation of the machine based on the thermal displacement compensation amount of the machine inferred by the inferential calculation section; and a learning model storage section which stores at least one learning model associated in advance with a combination of operations of the machine. In addition, the inferential calculation section is configured to infer the thermal displacement compensation amount of the machine by selectively using, based on the condition of the operation of the machine specified by the condition specifying section, at least one learning model from the learning models stored in the learning model storage section.

The thermal displacement compensation system may further include a feature quantity creating section which creates a feature quantity characterizing a thermal state due to the operation of the machine, from the state quantity detected by the state quantity detecting section, and the inferential calculation section may infer the thermal displacement compensation amount of the machine from the feature quantity.

A numerical controller according to an aspect of the present invention includes the condition specifying section and the state quantity detecting section which are described above.

A thermal displacement compensation method according to an aspect of the present invention includes the steps of: specifying a condition of an operation of a machine; detecting a state quantity indicating a state of an operation of the machine; inferring a thermal displacement compensation amount of the machine from the state quantity; performing a thermal displacement compensation of the machine based on the thermal displacement compensation amount; and generating or updating a learning model by machine learning that uses the state quantity. In addition, in the inferring step, a learning model to be used based on a condition of the operation of the machine specified in the condition specifying step is selected from at least one learning model associated in advance with a combination of conditions of the operation of the machine, and the thermal displacement compensation amount of the machine is inferred using the selected learning model.

The thermal displacement compensation method may further include a step of creating a feature quantity characterizing a thermal state due to the operation of the machine, from the state quantity, wherein in the inferring step, the thermal displacement compensation amount of the machine may be inferred from the feature quantity, and in the step of generating or updating a learning model, the learning model may be generated or updated by machine learning the uses the feature quantity.

A thermal displacement compensation method according to another aspect of the present invention includes the steps of: specifying a condition of an operation of a machine; detecting state quantity indicating a state of the operation of the machine; inferring a thermal displacement compensation amount of the machine from the state quantity; and performing a thermal displacement compensation of the machine based on the thermal displacement compensation amount. In addition, in the inferring step, a learning model to be used based on the condition of the operation of the machine specified in the condition specifying step is selected from at least one learning model associated in advance with a combination of conditions of the operation of the machine, and the thermal displacement compensation amount of the machine is inferred using the selected learning model.

The thermal displacement compensation method may further include a step of creating a feature quantity characterizing a thermal state due to the operation of the machine, from the state quantity, wherein in the inferring step, the thermal displacement compensation amount of the machine may be inferred from the feature quantity.

A learning model set according to an aspect of the present invention is a learning model set formed by associating each of a plurality of learning models with a combination of conditions under which a thermal displacement compensation of a machine is to be performed, wherein each of the plurality of learning models is a learning model generated or updated based on a state quantity indicating a state of an operation of the machine under the condition of the operation of the machine. In addition, one learning model is selected, based on a condition of an operation of the machine, from the plurality of learning models, and the selected learning model is to be used in inference processing of a thermal displacement compensation amount of the machine.

According to the present invention, since machine learning can be performed based on a state quantity of a machine in a factory detected in each situation with respect to a learning model selected in accordance with an installation environment of the machine, highly efficient machine learning can be performed while preventing over-learning, and since a thermal displacement compensation of a machine in a factory using a learning model selected in accordance with an installation environment or the like of the machine is performed, accuracy of thermal displacement compensation of the machine improves.

### BRIEF DESCRIPTION OF THE DRAWINGS

FIG. 1 is a schematic functional block diagram of a thermal displacement compensation system according to a first embodiment;

FIG. 2 is a diagram illustrating a model of an environmental condition of an operation of a machine;

FIG. 3 is a schematic functional block diagram of a thermal displacement compensation system according to a second embodiment;

FIG. 4 is a schematic functional block diagram of a thermal displacement compensation system according to a third embodiment;

FIG. 5 is a schematic functional block diagram of a thermal displacement compensation system according to a fourth embodiment;

FIG. 6 is a schematic functional block diagram of a thermal displacement compensation system according to a fifth embodiment;

FIG. 7 is a schematic functional block diagram showing a modification of the thermal displacement compensation system according to the fifth embodiment;

FIG. 8 is a schematic functional block diagram of a thermal displacement compensation system according to a sixth embodiment;

FIG. 9 is a schematic flow chart of processing executed on a thermal displacement compensation system according to the present invention;

FIG. 10 is a schematic flow chart of processing executed on a thermal displacement compensation system according to the present invention; and

FIG. 11 is a schematic hardware configuration diagram showing main parts of a numerical controller and a machine learning apparatus according to an embodiment of the present invention.

### DETAILED DESCRIPTION OF THE PREFERRED EMBODIMENTS

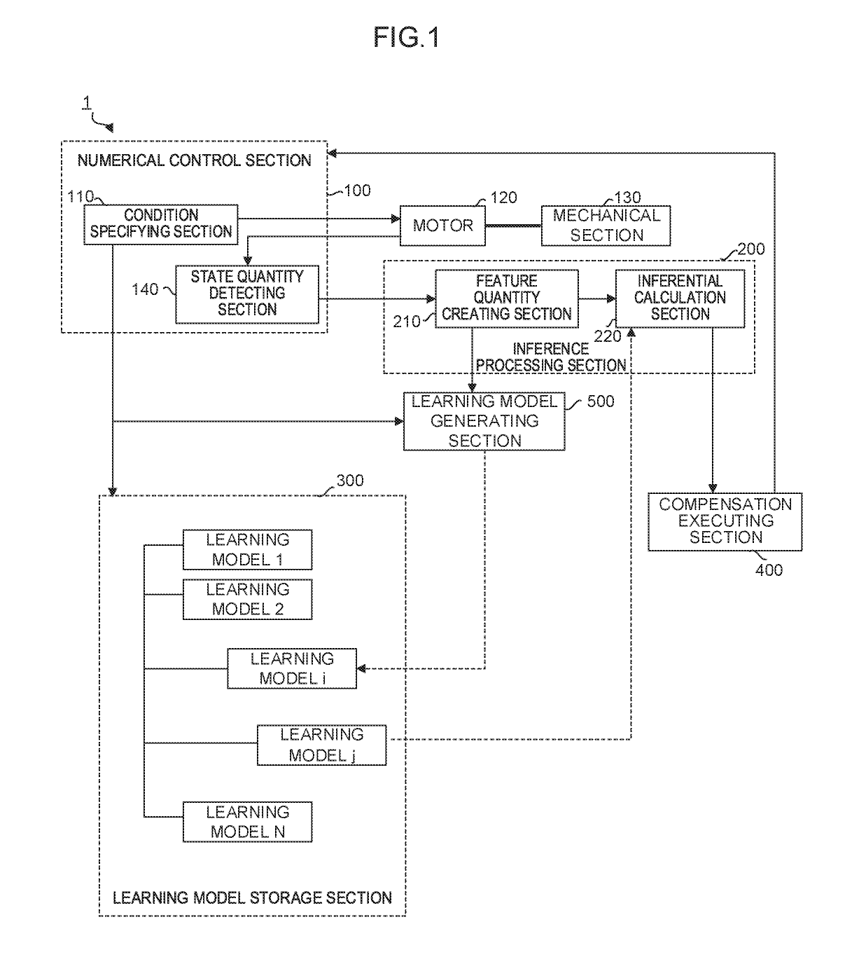

FIG. 1 is a schematic functional block diagram of a thermal displacement compensation system 1 according to a first embodiment

The respective functional blocks shown in FIG. 1 are realized as a processor such as a CPU or a GPU provided in a computer such as a numerical controller, a cell computer, a host computer, or a cloud server controls operations of various parts of an apparatus in accordance with each system program.

The thermal displacement compensation system 1 according to the present embodiment includes a numerical control section 100 as an edge device, an inference processing section 200, and a learning model storage section 300. The numerical control section 100 serves as at least an object of observation/inference of a state. The inference processing section 200 performs inference with respect to a state of the edge device. The learning model storage section 300 stores and manages a plurality of learning models. The thermal displacement compensation system 1 according to the present embodiment further includes a compensation executing section 400 and a learning model generating section 500. The compensation executing section 400 performs a thermal displacement compensation based on a result of an inference by the inference processing section 200 with respect to the state of the edge device. The learning model generating section 500 creates and updates a learning model stored in the learning model storage section 300.

The numerical control section 100 according to the present embodiment controls a machine by executing blocks of a machining program stored in a memory (not shown). The numerical control section 100 is implemented as, for example, a numerical controller, sequentially reads and analyzes blocks of the machining program stored in the memory (not shown), calculates an amount of movement of a motor 120 per control period based on a result of the analysis, and controls the motor 120 in accordance with the calculated amount of movement per control period. The machine controlled by the numerical control section 100 includes a mechanical section 130 driven by the motor 120, and when the mechanical section 130 is driven, for example, a tool and a workpiece move relative to each other and the workpiece is machined. Moreover, while omitted in FIG. 1, as many motors 120 as the number of axes provided in the mechanical section 130 of a machine tool are provided. A single mechanical section may be driven by a plurality of motors.

A condition specifying section 110 provided in the numerical control section 100 specifies a condition (such as an environmental condition) of an operation of the numerical control section 100 (and a machine controlled by the numerical control section 100) Examples of an environmental condition include an installation site of the machine (whether or not the installation site is a temperature-controlled room), and a position of the machine to be a compensation object and a position and a thermal state of other heat sources at the installation site of the machine (a positional relationship with a door and an opened/closed state of the door, a positional relationship with an air conditioner and a set temperature of the air condition, a positional relationship with a heater and a set temperature of the heater, or a positional relationship with other machines and an operating state of the other machines such as a spindle speed or a feed rate). The condition specifying section 110 specifies (outputs) a condition set to the numerical control section 100 via an input device (not shown) by a worker, a condition set to the numerical control section 100 by another computer connected via a network or the like, a condition commanded by the machining program, a condition detected by a device such as a sensor separately provided in the numerical control section 100, and the like with respect to each section of the numerical control section 100 as necessary and, at the same time, specifies (outputs) the conditions to the learning model storage section 300 and the learning model generating section 500. The condition specifying section 110 has a role of notifying each section of the thermal displacement compensation system 1 of a condition in a current machining operation of the numerical control section 100 as an edge device, as a condition of selecting a learning model.

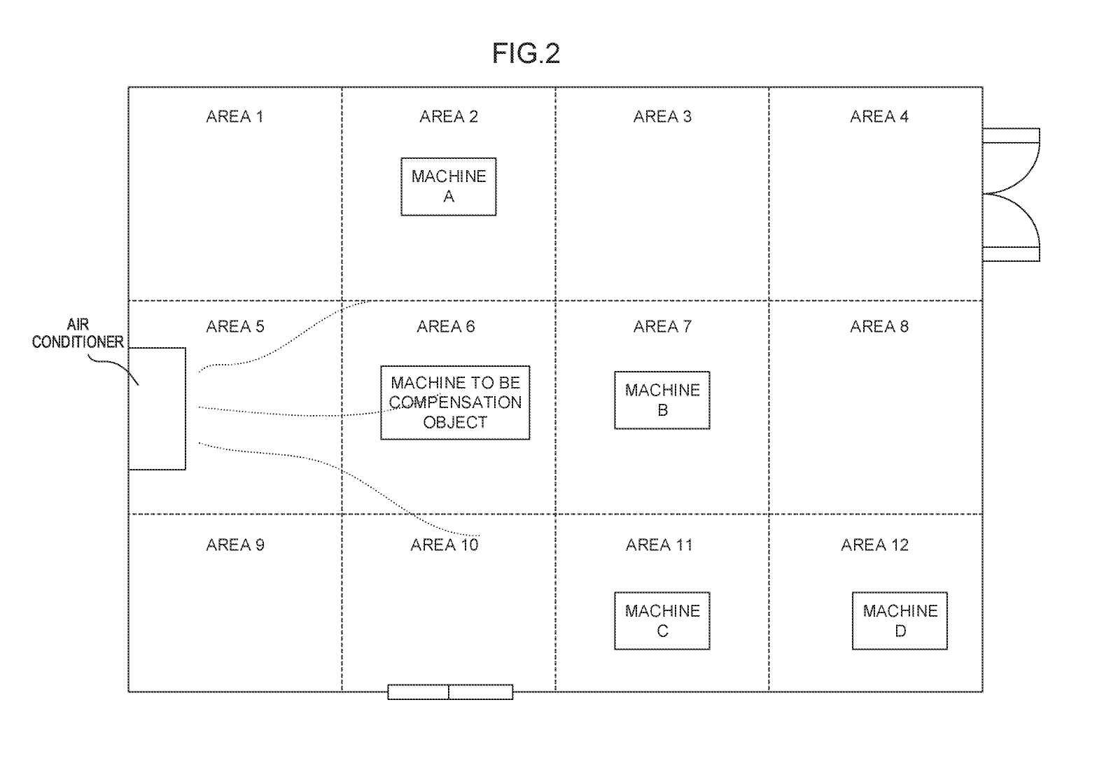

For example, as shown in FIG. 2, when an environment managed by the thermal displacement compensation system 1 is divided into a plurality of areas, an environmental condition of an operation of the numerical control section 100 (and the machine controlled by the numerical control section 100) is expressed in terms of how the machine to be a compensation object, as well as a door, an air conditioner, a heater, and other machines as heat sources are installed in each area. For example, in the example shown in FIG. 2, the machine to be a compensation object is installed in area 6, doors are installed in areas 4 and 10, an air conditioner is installed in area 5, and other machines are installed in areas 2, 7, 11, and 12.

In addition, a thermal state of each heat source can be defined by a state of each heat source in the environment in which the machine is installed. For example, a thermal state of a door as a heat source can be classified according to whether the door is in an open state or closed state, and thermal states of an air conditioner and a heater as heat sources can be set by set temperatures. In addition, a thermal state of another machine as a heat source may be classified according to an amount of heat generation in accordance with an operation of the other machine such as a low operation (low temperature), an intermediate operation (intermediate temperature), and a high operation (high temperature) or, for example, an operating state of another machine (such as an internal temperature, a spindle speed, a feed rate, or a load state of the machine) may be directly used as a parameter indicating the thermal state of the other machine. The numerical control section 100 can obtain a thermal state of each heat source based on a setting by a worker, a setting of an air conditioner or a setting of an heater acquired via a network (not shown), or an operating state of another machine (such as an internal temperature, a spindle speed, a feed rate, or a load state of the machine).

A state quantity detecting section 140 provided in the numerical control section 100 detects a state of an operation of the numerical control section 100 (and the machine controlled by the numerical control section 100) as a state quantity. Examples of a state quantity of an operation of the numerical control section 100 (and the machine controlled by the numerical control section 100) include ambient temperature of the machine and temperature of each location in the machine. For example, the state quantity detecting section 140 detects, as a state quantity, a value of a current flowing through the numerical control section 100 or the motor 120 driving the mechanical section 130 of a machine tool controlled by the numerical control section 100 or a detection value detected by a device such as a sensor separately provided in each section. The state quantity detected by the state quantity detecting section 140 is output to the inference processing section 200 and the learning model generating section 500.

The inference processing section 200 according to the present embodiment observes a state of the numerical control section 100 as an edge device (and the machine controlled by the numerical control section 100) and infers a thermal displacement compensation amount of each axis of the machine controlled by the numerical control section 100 based on a result of the observation. For example, the inference processing section 200 can be implemented as a numerical controller, a cell computer, a host computer, a cloud server, a machine learning apparatus, or the like.

A feature quantity creating section 210 provided in the inference processing section 200 creates a feature quantity indicating characteristics of a thermal state due to an operation of the numerical control section 100 (and the machine controlled by the numerical control section 100) based on the state quantity detected by the state quantity detecting section 140. The feature quantity indicating characteristics of the thermal state due to an operation of the numerical control section 100 (and the machine controlled by the numerical control section 100) created by the feature quantity creating section 210 is information useful as a criterion for inferring a thermal displacement amount of the numerical control section 100 (and the machine controlled by the numerical control section 100). In addition, the feature quantity indicating characteristics of the thermal state due to an operation of the numerical control section 100 (and the machine controlled by the numerical control section 100) created by the feature quantity creating section 210 is used as input data when an inferential calculation section 220 (to be described later) performs an inference using a learning model. The feature quantity indicating characteristics of the thermal state due to an operation of the numerical control section 100 (and the machine controlled by the numerical control section 100) created by the feature quantity creating section 210 may be, for example, a load on a spindle detected by the state quantity detecting section 140 which is sampled at prescribed sampling intervals during a prescribed period in the past or a peak value during a prescribed period in the past of a speed of the motor 120 detected by the state quantity detecting section 140. The feature quantity creating section 210 preprocesses and normalizes the state quantity detected by the state quantity detecting section 140 to enable the inferential calculation section 220 to handle the state quantity.

The inferential calculation section 220 provided in the inference processing section 200 infers a thermal displacement compensation amount of each axis of the machine controlled by the numerical control section 100 based on a learning model selected from the learning model storage section 300 based on a current condition of an operation of the numerical control section 100 (and the machine controlled by the numerical control section 100) and on the feature quantity created by the feature quantity creating section 210. The inferential calculation section 220 is realized by applying a learning model stored in the learning model storage section 300 to a platform capable of executing inference processing by machine learning. The inferential calculation section 220 may be configured to, for example, perform inference processing using a multi-layered neural network or perform inference processing using a known learning algorithm for machine learning such as a Bayesian network, a support vector machine, or a Gaussian mixture model. The inferential calculation section 220 may be configured to, for example, perform inference processing using a learning algorithm such as supervised learning, unsupervised learning, or reinforcement learning. On addition, the inferential calculation section 220 may be capable of respectively executing inference processing based on a plurality of learning algorithms. The inferential calculation section 220 constitutes a machine learning device based on a learning model for machine learning selected from the learning model storage section 300 and infers a thermal displacement compensation amount of each axis of the machine controlled by the numerical control section 100 by executing inference processing using the feature quantity created by the feature quantity creating section 210 as input data of the machine learning device.

The learning model storage section 300 according to the present embodiment is capable of storing a plurality of learning models associated with a combination of conditions of an operation of the numerical control section 100 (and the machine controlled by the numerical control section 100) specified by the condition specifying section 110. The learning model storage section 300 can be mounted onto, for example, the numerical control section 100, a cell computer, a host computer, a cloud server, or a database server.

The learning model storage section 300 stores a plurality of learning models 1, 2, . . . , N associated with a combination of conditions (including an installation environment of a machine inside a factory or the like) of an operation of the numerical control section 100 (and the machine controlled by the numerical control section 100) specified by the condition specifying section 110. A combination of conditions (including an installation environment of a machine inside a factory or the like) of an operation of the numerical control section 100 (and the machine controlled by the numerical control section 100) as described herein means a combination related to values that can be taken by each condition, a range of values of each condition, and an enumeration of values of each condition and, for example, when a machine is installed in a temperature-controlled room, positions and thermal states of other heat source at the installation site of the machine are modeled as shown in FIG. 2, and a spindle speed of the machine is set to 500 to 1000 [min⁻¹] and a feed rate thereof is set to 200 to 300 [mm/min], a matrix of respective element conditions [installed in temperature-controlled room, none, machine (high temperature) , none, door (open), air conditioner (26° C.), machine to be compensation object, machine (intermediate temperature), none, none, door (closed), machine (intermediate temperature), machine (stopped), 500 to 1000 [min⁻¹], 200 to 300 [mm/min]] can be used as one combination of conditions of an operation of the numerical control section 100 (and the machine controlled by the numerical control section 100).

The learning model stored in the learning model storage section 300 is stored as information capable of constructing one learning model adaptable to inference processing in the inferential calculation section 220. The learning model stored in the learning model storage section 300 can be stored as the number of neurons (perceptrons) of each layer, a weight parameter between neurons (perceptrons) of each layer, and the like in the case of a learning model using a learning algorithm of a multi-layered neural network, and the learning model stored in the learning model storage section 300 can be stored as a transition probability between nodes constituting a Bayesian network in the case of a learning model using a learning model of a Bayesian network. Each of the learning models stored in the learning model storage section 300 may be a learning model using a same learning algorithm or a learning model using a different learning algorithm, and the learning model stored in the learning model storage section 300 may be a learning model using any kind of learning algorithm as long as the Learning model can be used in inference processing by the inferential calculation section 220.

The Learning model storage section 300 may store one learning model in association with a combination of conditions of an operation of one numerical control section 100 (and the machine controlled by the numerical control section 100) or may associate and store a learning model using two or more different learning algorithms with a combination of conditions of an operation of one numerical control section 100 (and the machine controlled by the numerical control section 100). The learning model storage section 300 may associate and store a learning model using a different learning algorithm with each of combinations having overlapping ranges of conditions of an operation of a plurality of numerical control sections 100 (and the machines controlled by the numerical control sections 100). At this point, by further defining conditions of use such as a required throughput and a learning algorithm type with respect to the learning model corresponding to a combination of conditions of an operation of the numerical control section 100 (and the machine controlled by the numerical control section 100), for example, the learning model storage section 300 enables a learning model in accordance with the inferential calculation section 220 of which inference processing that can be executed and processing capacity differ from another inferential calculation section 220 to be selected with respect to a combination of conditions of an operation of the numerical control section 100 (and the machine controlled by the numerical control section 100).

When the learning model storage section 300 receives a read/write request of a learning model including a combination of conditions of an operation of the numerical control section 100 (and the machine controlled by the numerical control section 100) from the outside, the learning model storage section 300 performs read/write with respect to the learning model stored in association with the combination of conditions of an operation or the numerical control section 100 (and the machine controlled by the numerical control section 100). At this point, the read/write request for a learning model may include information on inference processing that can be executed by the inferential calculation section 220 and processing capacity of the inferential calculation section 220 and, in such a case, the learning model storage section 300 performs read/write with respect to the learning model associated with the combination of conditions of an operation of the numerical control section 100 (and the machine controlled by the numerical control section 100) and with the inference processing that can be executed by the inferential calculation section 220 and processing capacity of the inferential calculation section 220. The learning model storage section 300 may be provided with a function which, in response to a read/write request of a learning model from the outside, causes read/write to be performed with respect to a learning model associated with (a combination of) conditions specified by the condition specifying section 110 based on the conditions. Providing such a function eliminates the need to provide the inferential calculation section 220 or the learning model generating section 500 with a function for requesting a learning model based on conditions specified by the condition specifying section 110.

Moreover, the learning model storage section 300 may be configured to encrypt and store a learning model generated by the learning model generating section 500 and to decrypt an encrypted learning model when the learning model is read by the inferential calculation section 220.

The compensation executing section 400 performs a thermal displacement compensation of the machine controlled by the numerical control section 100 based on a thermal displacement compensation amount or each axis of the machine controlled by the numerical control section 100 inferred by the inference processing section 200. The compensation executing section 400 performs a thermal displacement compensation of the machine controlled by the numerical control section 100 by, for example, commanding a compensation amount of each axis to the numerical control section 100.

The learning model generating section 500 generates or updates (performs machine learning with respect to) a learning model stored in the learning model storage section 300 based on a condition of an operation of the numerical control section 100 (and the machine controlled by the numerical control section 100) specified by the condition specifying section 110 and a feature quantity indicating characteristics of a thermal state due to an operation of the numerical control section 100 (and the machine controlled by the numerical control section 100) created by the feature quantity creating section 210. The learning model generating section 500 selects a learning model to be an object of generation or update based on a condition of an operation of the numerical control section 100 (and the machine controlled by the numerical control section 100) specified by the condition specifying section 110, and performs, with respect to the selected learning model, machine learning that uses a feature quantity indicating characteristics of a thermal state due to an operation of the numerical control section 100 (and the machine controlled by the numerical control section 100) created by the feature quantity creating section 210. Examples of timing at which the learning model generating section 500 performs learning include a timing at which a worker manually sets a thermal displacement compensation amount of each axis of the machine with respect to the numerical control section 100 and when the thermal displacement compensation amount of each axis of the machine is set by other thermal displacement compensation means. In this case, when an operation of the machine based on the set thermal displacement compensation amount is normally performed (for example, when a worker verifies that a workpiece with prescribed accuracy has been processed), the learning model generating section 500 performs, with respect to a learning model selected based on the condition of an operation of the numerical control section 100 (and the machine controlled by the numerical control section 100), generation or update (machine learning) of the learning model using the feature quantity indicating characteristics of a thermal state due to an operation of the numerical control section 100 (and the machine controlled by the numerical control section 100) created by the feature quantity creating section 210 as a state variable and a set thermal displacement compensation amount of each axis as labeled data.

When a learning model associated with (a combination of) conditions of an operation of the numerical control section 100 (and the machine controlled by the numerical control section 100) specified by the condition specifying section 110 is not stored in the learning model storage section 300, the learning model generating section 500 newly generates a learning model associated with (the combination of) conditions, but when a learning model associated with (a combination of) the conditions of an operation of the numerical control section 100 (and the machine controlled by the numerical control section 100) specified by the condition specifying section 110 is stored in the learning model storage section 300, the learning model generating section 500 updates the learning model by performing machine learning with respect to the learning model. When a plurality of learning models associated with (a combination of) conditions of an operation of the numerical control section 100 (and the machine controlled by the numerical control section 100) specified by the condition specifying section 110 are stored in the learning model storage section 300, the learning model generating section 500 may perform machine learning with respect to each of the learning models or may perform, machine learning only with respect to a part of the learning models based on a learning process that can be executed by the learning model generating section 500 or processing capacity of the learning model generating section 500.

The learning model generating section 500 may modify a learning model stored in the learning model storage section 300 to generate a new learning model. Examples of a modification of a learning model by the learning model generating section 500 include generation of a distilled model. A distilled model refers to a learned model obtained by performing learning from scratch in another machine learning device using an output in response to an input to a machine learning device with a built-in learned model. The learning model generating section 500 is capable of storing a distilled model obtained through such a process (referred to as a distillation process) as a new learning model the learning model storage section 300 and utilizing the distilled model. Generally, since a distilled model is capable of producing a degree of accuracy comparable to that of an original learned model despite having a smaller size than the original learned model, a distilled model is better suited for distribution to other computers via a network and the like.

Other examples of a modification of a learning model by the learning model generating section 500 include integration of learning models. When structures of two or more learning models stored in association with (a combination of) conditions of an operation of the numerical control section 100 (and the machine controlled by the numerical control section 100) are similar to each other and when, for example, a value of each weight parameter is within a prescribed threshold set in advance, the learning model generating section 500 may first integrate (combinations of) conditions of an operation of the numerical control section 100 (and the machine controlled by the numerical control section 100) associated with the learning models and then store any of the two or more learning models with similar structures in association with the integrated (combinations of) conditions.

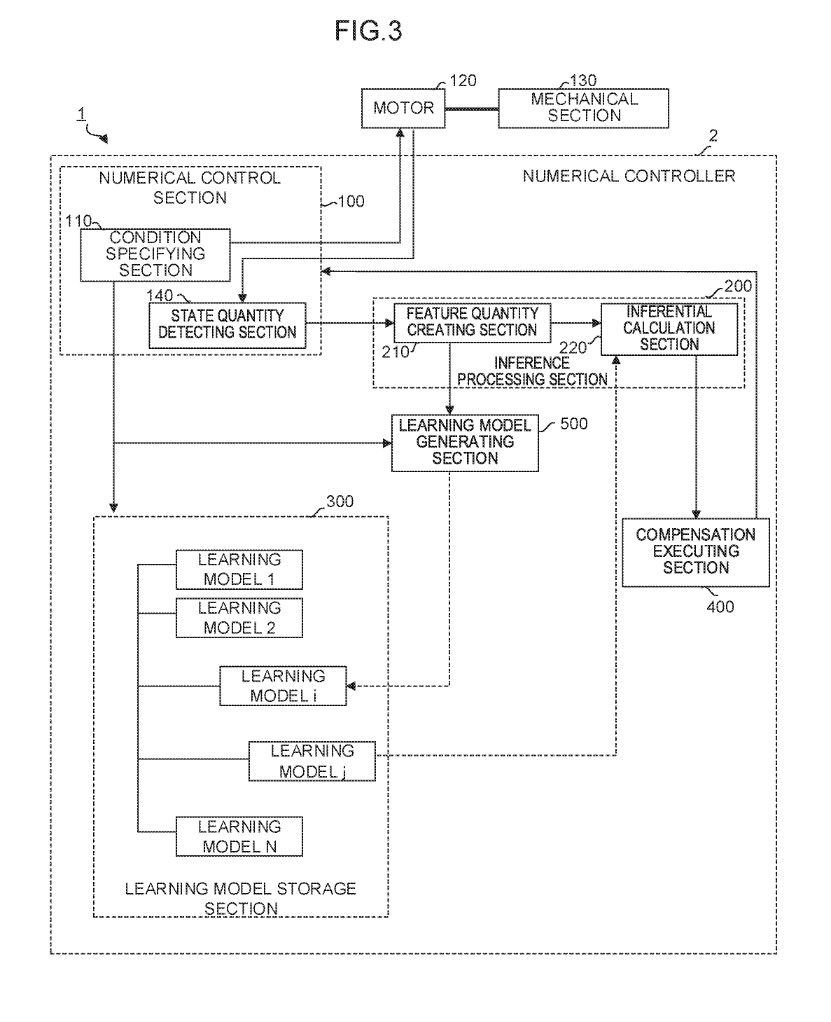

FIG. 3 is a schematic functional block diagram of the thermal displacement compensation system 1 according to a second embodiment.

In the thermal displacement compensation system 1 according to the present embodiment, each functional block is mounted to a single numerical controller 2. By adopting such a configuration, the thermal displacement compensation system 1 according to the present embodiment infers a thermal displacement compensation amount of each axis of the machine controlled by the numerical control section 100 using a different learning model in accordance with an installation environment of a machine controlled by the numerical controller 2, and performs a thermal displacement compensation of each axis of the machine based on a result of the inference. In addition, each learning model in accordance with a condition of an operation of the numerical control section 100 (and the machine controlled by the numerical control section 100) can be generated/updated by one numerical controller 2.

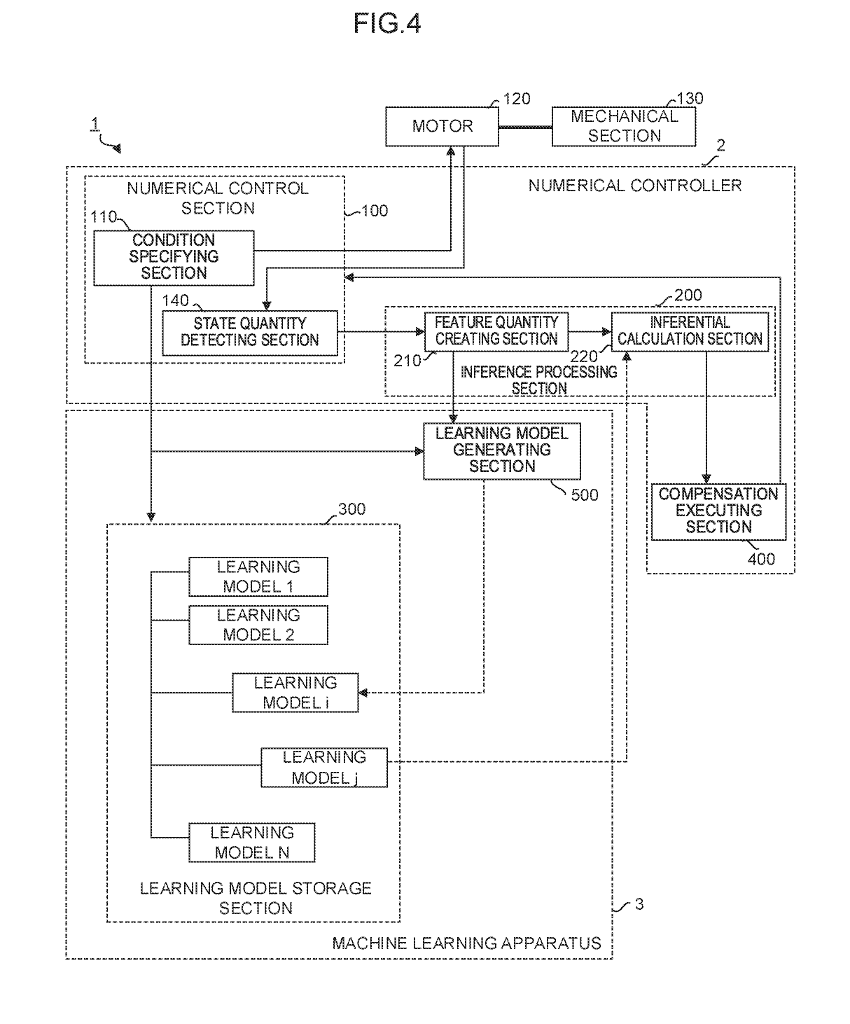

FIG. 4 is a schematic functional block diagram of the thermal displacement compensation system 1 according to a third embodiment.

In the thermal displacement compensation system 1 according to the present embodiment, the numerical control section 100, the inference processing section 200, and the compensation executing section 400 are mounted on the numerical controller 2, and the learning model storage section 300 and the learning model generating section 500 are mounted on a machine learning apparatus 3 connected to the numerical controller 2 via a standard interface or network. The machine learning apparatus 3 may be mounted on a cell computer, a host computer, a cloud server, or a database server. By adopting such a configuration, since inference processing using a learned model which is relatively light processing can be executed on the numerical controller 2 and generation/update processing of a learning model which is relatively heavy processing can be executed on the machine learning apparatus 3, operations of the thermal displacement compensation system 1 can be performed without interfering with intrinsic operations of the numerical controller 2.

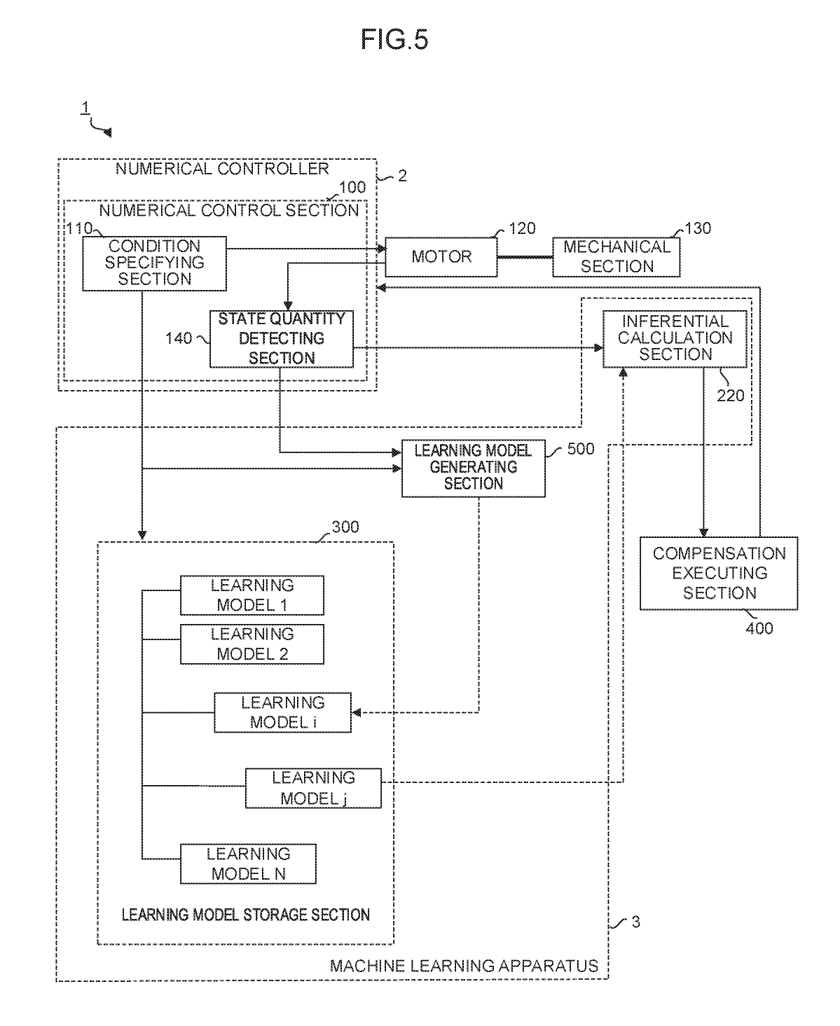

FIG. 5 is a schematic functional block diagram, of the thermal displacement compensation system 1 according to a fourth embodiment.

In the thermal displacement compensation system 1 according to the present embodiment, the numerical control section 100 is mounted on the numerical controller 2, and the inferential calculation section 220, the learning model storage section 300, and the learning model generating section 500 are mounted on the machine learning apparatus 3 connected to the numerical controller 2 via a standard interface or network. In addition, the compensation executing section 400 is separately provided. Moreover, in the thermal displacement compensation system 1 according to the present embodiment, the configuration of the feature quantity creating section 210 is omitted on the assumption that a state quantity detected by the state quantity detecting section 140 is data that can be used without modification in inference processing by the inferential calculation section 220 and generation/update processing of a learning model by the learning model generating section 500. By adopting such a configuration, since inference processing using a learned model and generation/update processing of a learning model can be executed on the machine learning apparatus 3, operations of the thermal displacement compensation system 1 can be performed without interfering with intrinsic operations of the numerical controller 2.

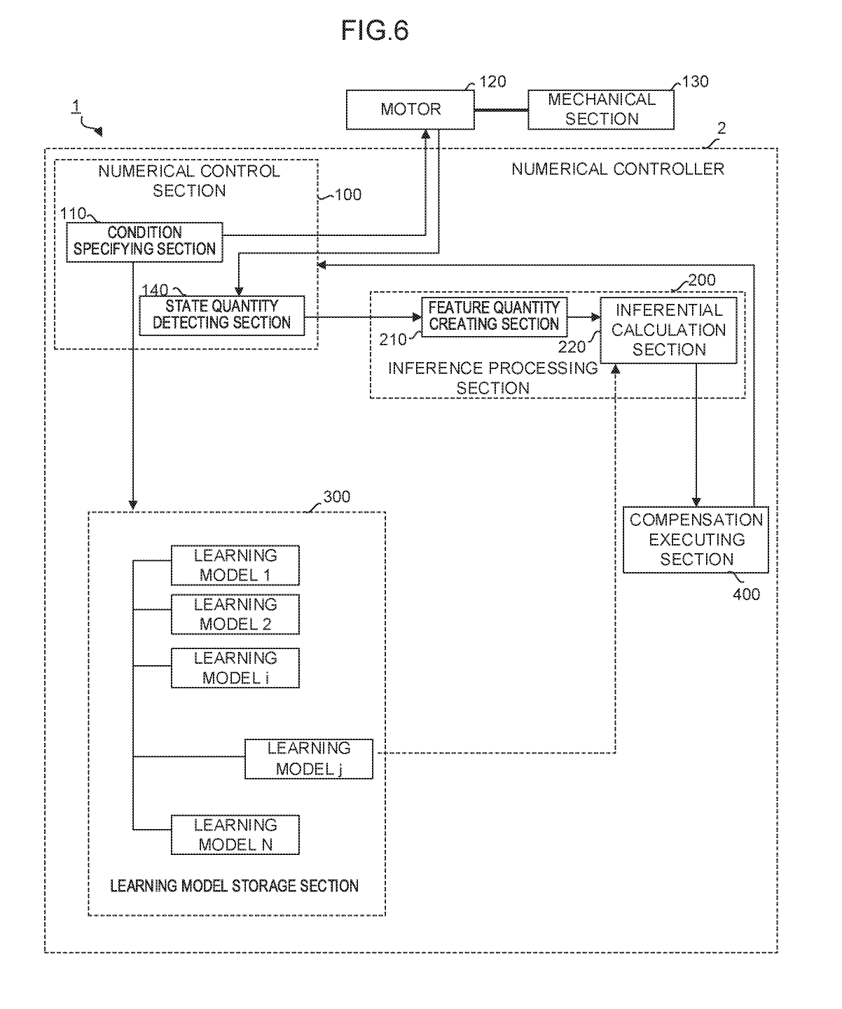

FIG. 6 is a schematic functional block diagram of the thermal displacement compensation system 1 according to a fifth embodiment.

In the thermal displacement compensation system 1 according to the present embodiment, each functional block is mounted to a single numerical controller 2. Moreover, in the thermal displacement compensation system 1 according to the present embodiment, a plurality of learned learning models associated with combinations of conditions of an operation of the numerical control section 100 (and the machine controlled by the numerical control section 100) are already stored in the learning model storage section 300, and the configuration of the learning model generating section 500 is omitted on the assumption that generation/update of learning models is not performed. By adopting such a configuration, for example, the thermal displacement compensation system 1 according to the present embodiment infers a thermal displacement compensation amount of each axis of the machine controlled by the numerical control section 100 using a different learning model in accordance with an installation environment of a machine controlled by the numerical controller 2, and performs a thermal displacement compensation of each axis of the machine based on a result of the inference. In addition, since arbitrary updating of a learning model is not performed, for example, the configuration described above may be adopted as a configuration of the numerical controller 2 to be shipped to a client.

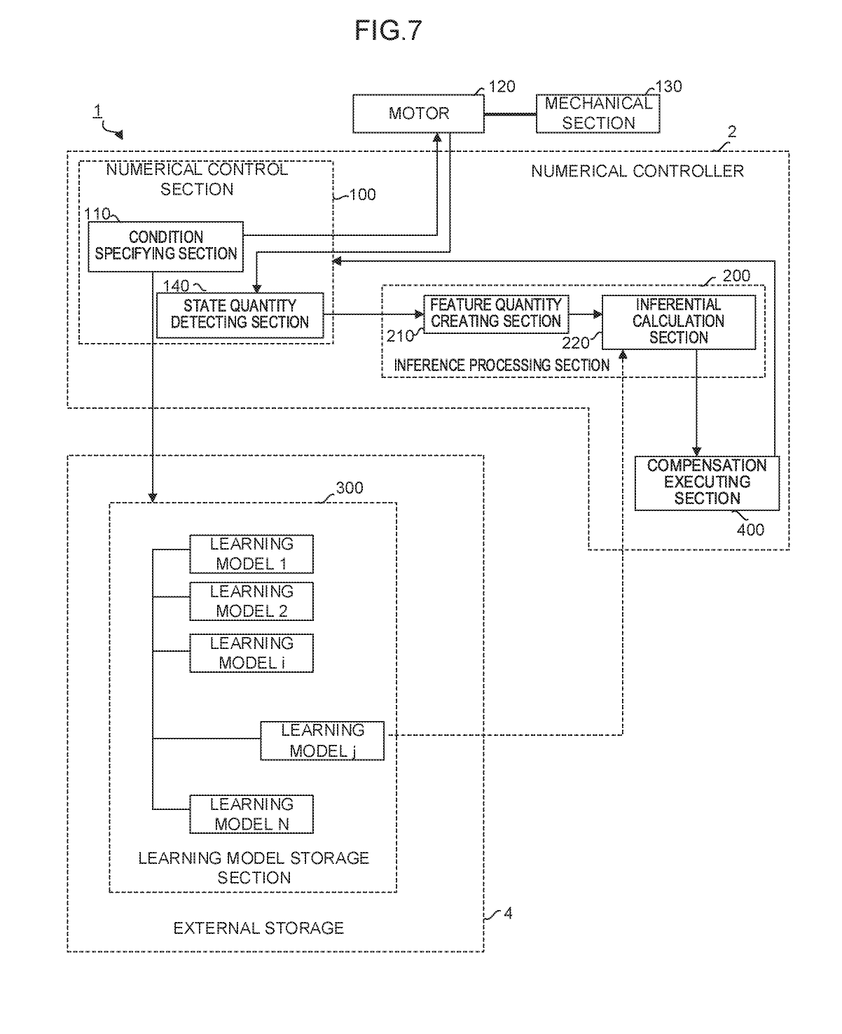

FIG. 7 s a schematic functional block diagram showing a modification of the thermal displacement compensation system 1 (FIG. 6) according to the fifth embodiment.

The thermal displacement compensation system 1 according to the present modification represents an example in which the learning model storage section 300 according to the fifth embodiment (FIG. 6) is mounted to an external storage 4 connected to the numerical controller 2. In the present modification, since storing learning models with large capacities in the external storage 4 enables a large number of learning models to be used and, at the same time, enables learning models to be read without involving a network and the like, the present modification is effective when inference processing is to be performed to real time.

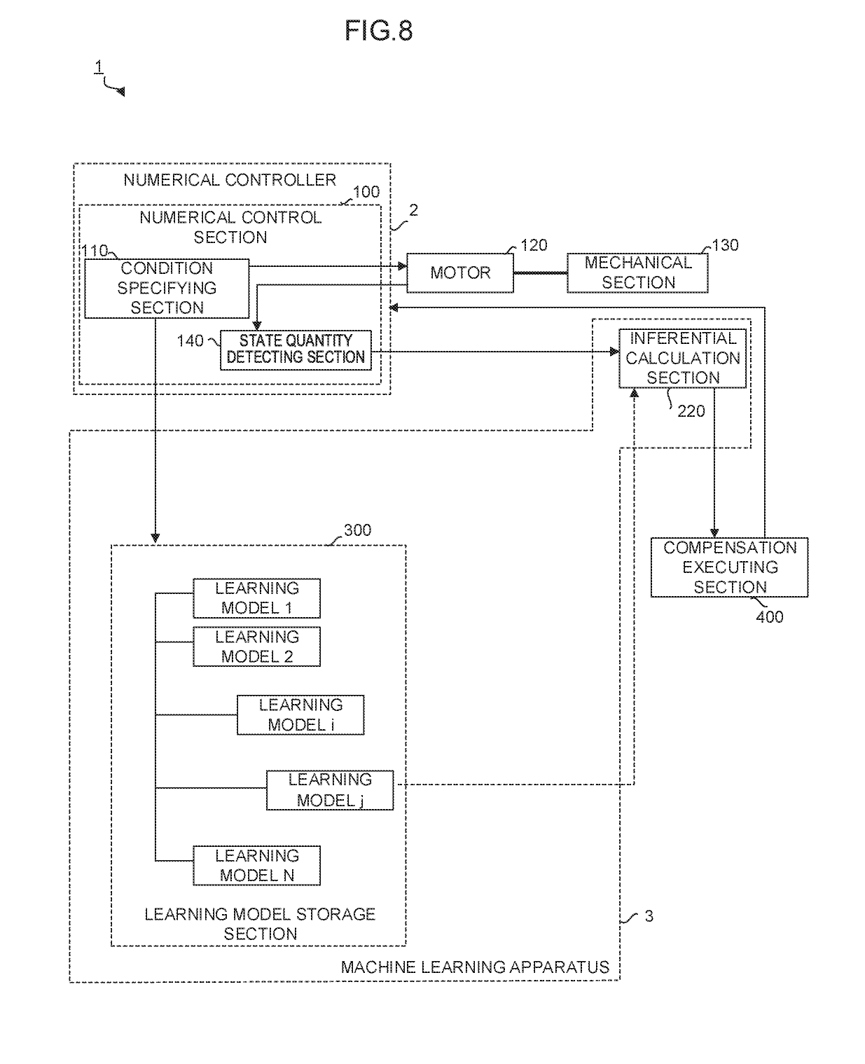

FIG. 8 is a schematic functional block diagram of the thermal displacement compensation system 1 according to a sixth embodiment.

In the thermal displacement compensation system 1 according to the present embodiment, the numerical control section 100 is mounted on the numerical controller 2, and the inferential calculation section 220 and the learning model storage section 300 are mounted on the machine learning apparatus 3 connected to the numerical controller 2 via a standard interface or network. The machine learning apparatus 3 may be mounted on a cell computer, a host computer, a cloud server, or a database server. Moreover, in the thermal displacement compensation system 1 according to the present embodiment, a plurality of learned learning models associated with combinations of conditions of an operation of the numerical control section 100 (and the machine controlled by the numerical control section 100) are already stored in the learning model storage section 300, and the configuration of the learning model generating section 500 is omitted on the assumption that generation/update of learning models is not performed. In addition, in the thermal displacement compensation system 1 according to the present embodiment, the configuration of the feature quantity creating section 210 is omitted on the assumption that a state quantity detected by the state quantity detecting section 140 is data that can be used without modification in inference processing by the inferential calculation section 220. By adopting such a configuration, for example, the thermal displacement compensation system 1 according to the present embodiment infers a thermal displacement compensation amount of each axis of the machine controlled by the numerical control section 100 using a different learning model in accordance with an installation environment of a machine controlled by the numerical controller 2, and performs a thermal displacement compensation of each axis of the machine based on a result of the inference. In addition, since arbitrary updating of a learning model is not performed, for example, the configuration described above may be adopted as a configuration of the numerical controller 2 to be shipped to a client.

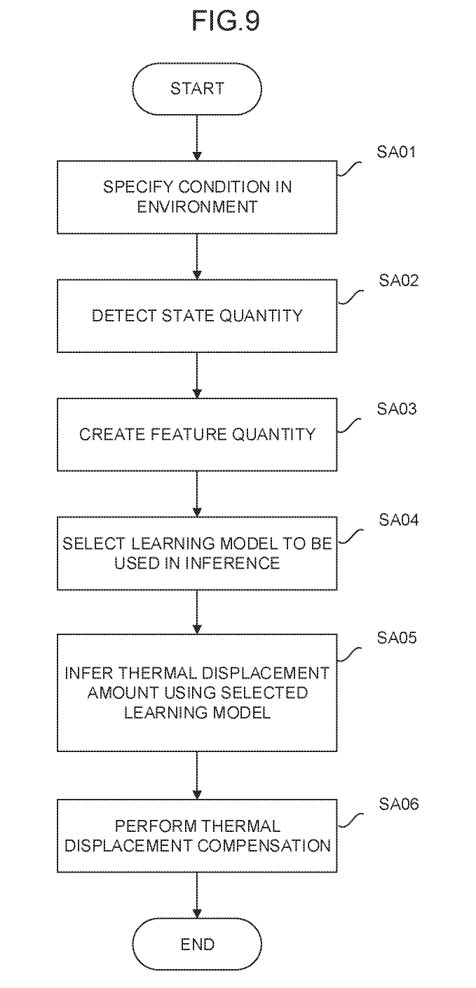

FIG. 9 is a schematic flow chart of processing executed by the thermal displacement compensation system 1 according to the present invention.

The flow chart shown in FIG. 9 illustrates a flow of processing in case where an update of a learning model in the thermal displacement compensation system 1 is not performed (fifth and sixth embodiments).
Step SA01: The condition specifying section 110 specifies a condition of an operation of the numerical control section 100 (and the machine controlled by the numerical control section 100)
Step SA02: The state quantity detecting section 140 detects a state of an operation of the numerical control section 100 (and the machine controlled by the numerical control section 100) as a state quantity.
Step SA03: The feature quantity creating section 210 creates a feature quantity indicating characteristics of a thermal state due to an operation of the numerical control section 100 (and the machine controlled by the numerical control section 100) based on the state quantity detected in step SA02.
Step SA04: The inferential calculation section 220 selects and reads a learning model corresponding to the condition of an operation of the numerical control section 100 (and the machine controlled by the numerical control section 100) specified in step SA01 from the learning model storage section 300 as a learning model to be used for inference.
Step SA05: The inferential calculation section 220 infers a thermal displacement compensation amount of each axis of the machine controlled by the numerical control section 100 based on the learning model read in step SA04 and the feature quantity created in step SA03.
Step SA06: The compensation executing section 400 performs a thermal displacement compensation based on the thermal displacement compensation amount of each axis of the machine inferred in step SA05.

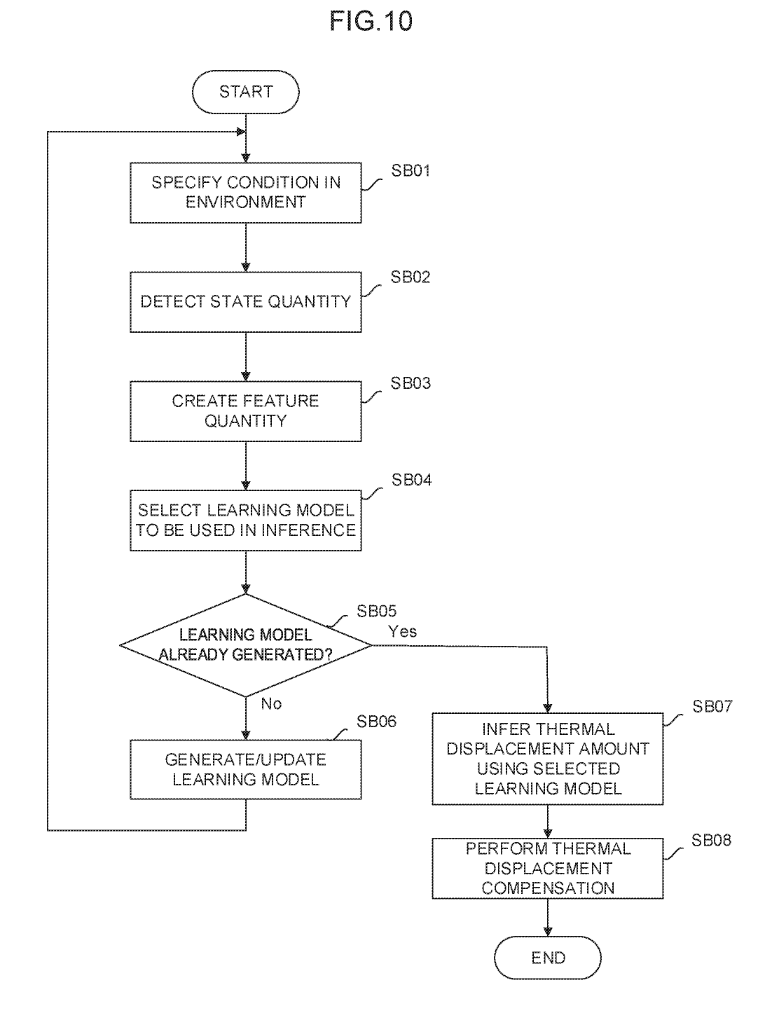

FIG. 10 is a schematic flow chart of processing executed by the thermal displacement compensation system 1 according to the present invention.

The flow chart shown in FIG. 10 illustrates a flow of processing in case where generation/update of a learning model in the thermal displacement compensation system 1 is performed (first to fourth embodiments).
Step SB01: The condition specifying section 110 specifies a condition of an operation of the numerical control section 100 (and the machine controlled by the numerical control section 100).
Step SB02: The state quantity detecting section 140 detects a state of an operation of the numerical control section 100 (and the machine controlled by the numerical control section 100) as a state quantity.
Step SB03: The feature quantity creating section 210 creates a feature quantity indicating characteristics of a thermal state due to an operation of the numerical control section 100 (and the machine controlled by the numerical control section 100) based on the state quantity detected in step SB02.
Step SB04: The inferential calculation section 220 selects and reads a learning model corresponding to the condition of an operation of the numerical control section 100 (and the machine controlled by the numerical control section 100) specified in step SB01 from the learning model storage section 300 as a learning model to be used for inference.
Step SB05: The learning model generating section 500 determines whether or not a learned learning model corresponding to the condition of an operation of the numerical control section 100 (and the machine controlled by the numerical control section 100) specified in step SB01 has been generated in the learning model storage section 300. When a learned learning model has been generated, the processing proceeds to step SB07, but when a learned learning model has not been generated, the processing proceeds to step SB06.
Step SB06: The learning model generating section 500 generates/updates the learning model corresponding to the condition of an operation of the numerical control section 100 (and the machine controlled by the numerical control section 100) specified in step SB01 based on the feature quantity created in step SB03, and the processing proceeds to step SB01.
Step SB07: The inferential calculation section 220 infers a thermal displacement compensation amount of each axis of the machine controlled by the numerical control section 100 based on the learning model read in step SB04 and the feature quantity created in step SB03.
Step SB08: The compensation executing section 400 performs a thermal displacement compensation based on the thermal displacement compensation amount of each axis of the machine inferred in step SB07.

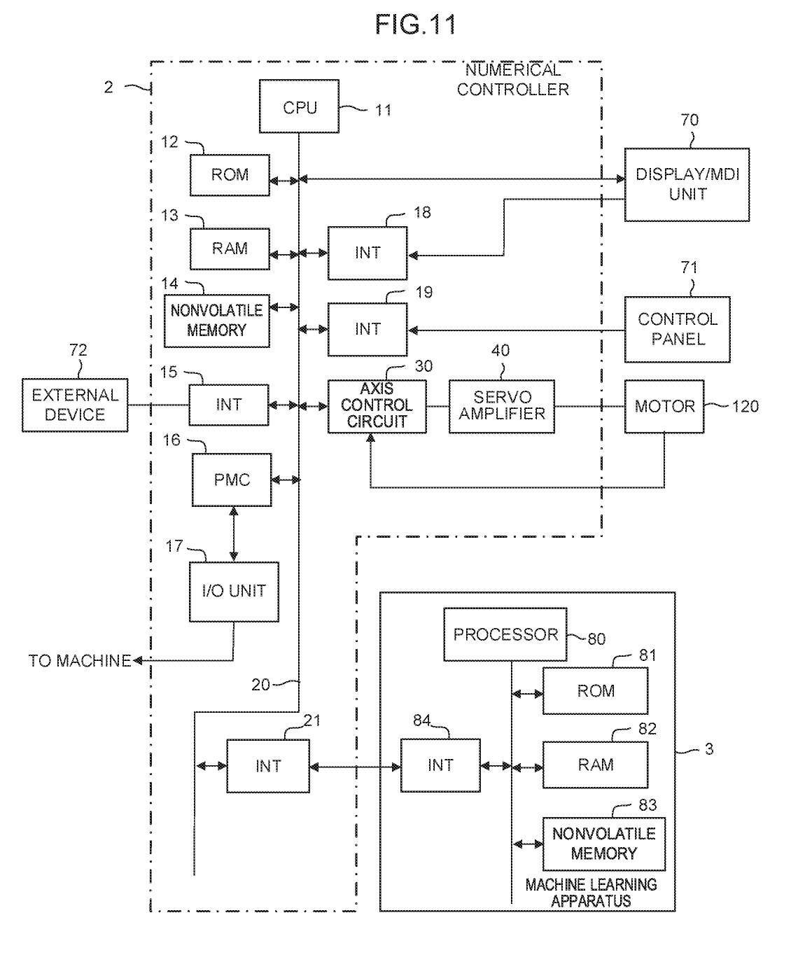

FIG. 11 is a schematic hardware configuration diagram showing main parts of a numerical controller and a machine learning apparatus according to an embodiment of the present invention.

A CPU 11 provided in the numerical controller 2 according to the present embodiment is a processor which controls the entire numerical controller 2. The CPU 11 reads a system program stored in a ROM 12 via a bus 20, and controls the entire numerical controller 2 in accordance with the system program. A RAM 13 temporarily stores temporary calculation data and display data, various data input by an operator via an input section (not shown), and the like.

A nonvolatile memory 14 is configured as a memory of which a storage state is retained even when a power supply of the numerical controller 2 is turned off by being backed up with a battery (not shown) or the like. The nonvolatile memory 14 stores a machining program read via an interface 15, a machining program input via a display/MDT unit 70 (to be described later), and the like. The machining program related to repetitive control stored in the nonvolatile memory 14 may be deployed on the RAM 13 during use. In addition, various system programs (including a system program for controlling communication with the machine learning apparatus 3 to be described later) necessary for operations of the numerical controller 2 are written in the ROM 12 in advance.

The interface 15 is an interface for connecting the numerical controller 2 with an external device 72 such as an adapter. Machining programs, various parameters, and the like are read from the external device 72. In addition, the program related to repetitive control, various parameters, and the like edited in the numerical controller 2 can be stored in external storage means via the external device 72. A programmable machine controller (PMC) 16 outputs a signal via an I/O unit 17 to peripheral apparatuses (for example, an actuator such as a robot hand for tool replacement) of a machine tool to control the peripheral apparatuses with a sequence program built into the numerical controller 2. In addition, the programmable machine controller 16 receives signals from various switches on a control panel and sensors arranged in a main body of the machine tool and, after performing necessary signal processing, hands over the processed signals to the CPU 11.

The display/MDI unit 70 is a manual data input device provided with a display, a keyboard, and the like, and an interface 18 receives commands and data from the keyboard of the display/MDI unit 70 and hands over the commands and data to the CPU 11. An interface 19 is connected to a control panel 71 provided with a manual pulse generator and the like to be used when manually driving each axis.

The display/MDI unit 70 is also capable of displaying an immediate value and a history of inferential evaluation values that represent a thermal displacement state of a machine. While a final result can be obtained by various methods such as a threshold discrimination method, a trend graph determination method, and an outlier detection method in embodiments of the proposed system, by visualizing a part of a process in which the result is obtained, a result consistent with industrial intuition of a worker actually operating a machine tool at a production side can be provided.

Upon receiving a movement command of an axis from the CPU 11, an axis control circuit 30 for controlling an axis provided in the machine tool outputs an axis command to a servo amplifier 40. The servo amplifier 40 receives the command and drives the motor 120 which moves an axis provided in the machine tool. The motor 120 of the axis has a built-in position/speed detector and performs position/speed feedback control by feeding back a position/speed feedback signal from the position/speed detector to the axis control circuit 30. While the hardware configuration diagram in FIG. 11 only shows one each of the axis control circuit 30, the servo amplifier 40, and the motor 120, in reality, as many components as the number of axes provided in the machine tool that is a control object are to be prepared.

An interface 21 is an interface for connecting the numerical controller 2 and the machine learning apparatus 3 with each other. The machine learning apparatus 3 is provided with a processor 80 which controls the entire machine learning apparatus 3, a ROM 81 which stores a system program and the like, a RAM 82 which performs temporarily storage during each process related to machine learning, and a nonvolatile memory 83 which stores learning models and the like. The machine learning apparatus 3 exchanges various pieces of data with the numerical controller 2 via an interface 84 and the interface 21.

While embodiments of the present invention have been described above, it is to be understood that the present invention is not limited to the examples presented in the embodiments and may be variously embodied by making suitable modifications thereto.

1. A thermal displacement compensation system which performs a thermal displacement compensation of a machine, the thermal displacement compensation system comprising:
a condition specifying section which specifies a condition of an operation of the machine;
a state quantity detecting section which detects a state quantity indicating a state of the operation of the machine;
an inferential calculation section which infers a thermal displacement compensation amount of the machine from the state quantity;
a compensation executing section which performs a thermal displacement compensation of the machine based on the thermal displacement compensation amount of the machine inferred by the inferential calculation section;
a learning model generating section which generates or updates a learning model by machine learning that uses the state quantity; and
a learning model storage section which stores at least one learning model generated by the learning model generating section in association with a combination of conditions specified by the condition specifying section, wherein
the inferential calculation section infers the thermal displacement compensation amount of the machine by selectively using, based on the condition of the operation of the machine specified by the condition specifying section, at least one learning model from the learning models stored in the learning model storage section.

2. The thermal displacement compensation system according to claim 1, further comprising a feature quantity creating section which creates a feature quantity characterizing a thermal state due to the operation of the machine, from the state quantity detected by the state quantity detecting section, wherein
the inferential calculation section infers the thermal displacement compensation amount of the machine from the feature quantity, and
the learning model generating section generates or updates the learning model by machine learning that uses the feature quantity.

3. The thermal displacement compensation system according to claim 1, wherein the learning model generating section generates a new learning model by performing a modification of an existing learning model stored by the learning model storage section.

4. The thermal displacement compensation system according to claim 1, wherein the learning model storage section encrypts and stores the learning model generated by the learning model generating section, and decrypts the encrypted learning model when the learning model is read by the inferential calculation section.

5. A thermal displacement compensation system which performs a thermal displacement compensation of a machine, the thermal displacement compensation system comprising:
a condition specifying section which specifies a condition of an operation of the machine;
a state quantity detecting section which detects a state quantity indicating a state of the operation of the machine;
an inferential calculation section which infers a thermal displacement compensation amount of the machine from the state quantity;
a compensation executing section which performs a thermal displacement compensation of the machine based on the thermal displacement compensation amount of the machine inferred by the inferential calculation section; and
a learning model storage section which stores at least one learning model associated in advance with a combination of operations of the machine, wherein
the inferential calculation section infers the thermal displacement compensation amount of the machine by selectively using, based on the condition of the operation of the machine specified by the condition specifying section, at least one learning model from the learning models stored in the learning model storage section.

6. The thermal displacement compensation system according to claim 5, further comprising a feature quantity creating section which creates a feature quantity characterizing a thermal state due to the operation of the machine, from the state quantity detected by the state quantity detecting section, wherein
the inferential calculation section infers the thermal displacement compensation amount of the machine from the feature quantity.

7. The thermal displacement compensation system according to claim 1, comprising:
a numerical controller comprising the condition specifying section; and the state quantity detecting section.

8. The thermal displacement compensation system according to claim 1, comprising:
a numerical controller comprising the condition specifying section; and the state quantity detecting section.

9. A thermal displacement compensation method, comprising the steps of:
specifying a condition of an operation of a machine;
detecting a state quantity indicating a state of the operation of the machine;
inferring a thermal displacement compensation amount of the machine from the state quantity;
performing a thermal displacement compensation of the machine based on the thermal displacement compensation amount; and
generating or updating a learning model by machine learning that uses the state quantity, wherein
in the inferring step, a learning model to be used based on a condition of the operation of the machine specified in the condition specifying step is selected from at least one learning model associated in advance with a combination of conditions of the operation of the machine, and the thermal displacement compensation amount of the machine is inferred using the selected learning model.

10. The thermal displacement compensation method according to claim 9, further comprising
a step of creating a feature quantity characterizing a thermal state due to the operation of the machine, from the state quantity, wherein
in the inferring step, the thermal displacement compensation amount of the machine is inferred from the feature quantity, and
in the step of generating or updating a learning model, the learning model is generated or updated by machine learning that uses the feature quantity.

11. A thermal displacement compensation method, comprising the steps of:
specifying a condition of an operation of a machine;
detecting a state quantity indicating a state of the operation of the machine;
inferring a thermal displacement compensation amount of the machine from the state quantity; and
performing a thermal displacement compensation of the machine based on the thermal displacement compensation amount, wherein
in the inferring step, a learning model to be used based on the condition of the operation of the machine specified in the condition specifying step is selected from at least one learning model associated in advance with a combination of conditions of the operation of the machine, and the thermal displacement compensation amount of the machine is inferred using the selected learning model.

12. The thermal displacement compensation method according to claim 11, further comprising
a step of creating a feature quantity characterizing a thermal state due to the operation of the machine, from the state quantity, wherein
in the inferring step, the thermal displacement compensation amount of the machine is inferred from the feature quantity.

13. A learning model set formed by associating each of a plurality of learning models with a combination of conditions under which a thermal displacement compensation of a machine is to be performed, wherein
each of the plurality of learning models is a learning model generated or updated based on a state quantity indicating a state of an operation of the machine under a condition of the operation of the machine, and
one learning model is selected, based on the condition of the operation of the machine, from the plurality of learning models, and the selected learning model is to be used in inference processing of a thermal displacement compensation amount of the machine.
